(19) United States
(12) Patent Application Publication
(10) Pub. No.: US 2025/0155260 A1
(43) Pub. Date: May 15, 2025

(54) MULTI-SCALE GLOBAL LAND USE MODEL BASED ON POINTS OF INTEREST

(71) Applicant: UT-Battelle, LLC, Oak Ridge, TN (US)

(72) Inventors: Junchuan Fan, Knoxville, TN (US); Gautam Thakur, Knoxville, TN (US)

(21) Appl. No.: 18/946,425

(22) Filed: Nov. 13, 2024

Related U.S. Application Data
(60) Provisional application No. 63/548,402, filed on Nov. 14, 2023.

(51) Int. Cl. G01C 21/00; G06F 16/29

(52) U.S. Cl. CPC G01C 21/3811; G06F 16/29

(57) ABSTRACT

This framework provides scalable land use characterization using Points of Interest (POIs) and non-POI geographic features. Leveraging open-access POI data and hierarchical spatial structures, it generates high-dimensional embeddings that capture spatial and semantic characteristics of land use for areas of interest (AOIs). An OSM-tag-based representation harmonizes diverse data sources, while a neural network language model produces embeddings optimized for multi-scale land use classification across geographic regions. Supervised classification models validate the robustness of AOI embeddings, revealing variations in semantic salience for different land use types. Results demonstrate that combining POIs with non-POI features and tailoring spatial and semantic granularities enhance land use characterization. Future directions include augmenting data and integrating temporal dynamics to improve representational accuracy and capture land use patterns more effectively.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### BACKGROUND OF THE INVENTION

The present invention relates generally to land use modeling and geospatial analysis. More specifically, it pertains to methods and systems for global-scale land use characterization that accurately reflect how humans utilize geographic spaces by capturing socio-economic activities.

Understanding global human dynamics and land use patterns is key for various applications, including population modeling, disaster response, urban planning, and monitoring human migration. Traditional land use models predominantly rely on high-resolution remote sensing (RS) imagery to analyze physical features of the Earth's surface, such as spectral signatures, shapes, and textures of ground objects. While RS imagery provides valuable information about physical land cover, it presents several limitations when used for comprehensive land use characterization.

One significant limitation is that high-resolution RS imagery is often difficult to access on a global scale due to high costs, limited availability, and data sharing restrictions. This inaccessibility hinders the development of comprehensive global land use models. Additionally, processing and analyzing large volumes of high-resolution RS imagery requires substantial computational resources, making it impractical for large-scale applications.

Furthermore, RS imagery primarily captures physical and spectral characteristics but does not effectively represent underlying human socio-economic activities. There exists a semantic gap between the physical features detectable by RS imagery and the socio-economic factors that define land use. As a result, important aspects of how humans interact with and utilize geographic spaces are not adequately captured, leading to less accurate or incomplete models.

In recent years, other geospatial data sources have emerged, such as demographic data, Points of Interest (POIs), GPS trajectories, and socially sensed data like social media check-ins. These data sources can offer insights into human socio-economic activities, which are closely linked to land use characteristics. However, effectively utilizing these data sources for large-scale land use modeling is challenging, as they remain fragmented, often specific to localized regions, and difficult to scale across different geographic areas.

POI data, for example, is widely available and reflects how humans interact with geographic spaces, capturing details relevant to land use characteristics. However, current approaches to POI-based land use modeling are often limited to single geographic regions, such as a city, and usually rely on one spatial scale or a specific semantic granularity. This limitation restricts their effectiveness at broader spatial scales and reduces the model's ability to reflect the complexity of land use in diverse locations with varying socio-economic characteristics. Additionally, the geographic context-such as social, economic, and cultural conditions-affects POI distribution and meaning, leading to spatial heterogeneity in land use characteristics. Conventional models fail to account for this heterogeneity and consequently struggle to generalize effectively across regions.

Although methods for POI-based land use modeling have evolved, they face challenges in integrating spatial and semantic information across diverse data sources. For example, POI data collected from various platforms lack standardized representations, and the spatial layout of POIs within a geographic region often goes unaccounted for, affecting the accuracy of land use predictions. Furthermore, existing models primarily rely on POI category frequencies, overlooking the spatial relationships among POIs and other geographic features within an area of interest (AOI). This reliance on isolated POI attributes rather than integrated spatial patterns limits the capacity of current models to characterize complex land use types accurately.

Accordingly, there is a need for improved methods and systems for global land use modeling that overcome the limitations of existing approaches. Such methods should be capable of capturing both the physical characteristics and the socio-economic activities associated with geographic areas, while being scalable and practical for global applications. An effective and practical solution can address the challenges posed by the heterogeneity of data sources, lack of standardized semantic representations, and the difficulty of integrating spatial and semantic dimensions of geospatial data.

### SUMMARY OF THE INVENTION

The present invention provides methods, systems, and apparatuses for predicting the land use type of an area of interest (AOI) by leveraging heterogeneous Points of Interest (POIs) data from multiple sources. Traditional land use models often rely on high-resolution remote sensing imagery, which can be limited by accessibility, computational demands, and a lack of socio-economic context. This invention addresses these limitations by utilizing POI semantics and geolocations, integrating them through a unified semantic framework, and employing neural network language models (NNLMs) to generate meaningful embeddings that capture both spatial and semantic information.

In one embodiment, the invention accesses POI information from various sources for a designated AOL. This information includes each POI's semantic category (e.g., restaurant, school) and its geolocation. To ensure consistency across diverse data types, a unified semantic framework is applied, where POI semantics from multiple sources are harmonized according to a standardized set of labels, such as those provided by OpenStreetMap (OSM) tags. This harmonization addresses the heterogeneity inherent in POI data, making it feasible to integrate data at a global scale. Duplicated POIs are detected and removed, and the remaining POIs are merged based on their spatial coordinates and standardized semantic categories.

In one embodiment, the invention organizes the POIs within the AOI according to a multi-level hierarchy based on road network information. By leveraging road network information, this hierarchical structure captures both the spatial distribution and semantic relationships among POIs within the AOL. The space is partitioned by road network into hierarchical segments (e.g., neighborhood blocks, city districts), represented by polygons at various levels, where each polygon at a particular level is nested within a polygon at the previous level. Each POI is assigned to all polygons containing its geolocation across these hierarchical levels. This process produces a spatially explicit corpus that links POI semantics to specific, nested geographic regions.

To effectively capture the complex spatial and semantic information, POI tags are structured hierarchically, where each tag corresponds to a “word” in the corpus. POI-tag sentences are derived from the highest-level polygons, and as the hierarchical levels progress downward, these sentences aggregate into paragraphs, documents, and ultimately a POI-tag corpus at the lowest level. This hierarchy allows the neural network language model (NNLM) to analyze POI tags in a structured manner, where both the immediate spatial context and broader semantic meaning are captured. The NNLM transforms each POI tag into an N-dimensional vector, where N is at least as large as the number of hierarchical levels, thereby encoding the spatial-semantic relationships of POIs, which can be referred to as POI embeddings.

AOI embeddings are generated by synthesizing the POI embeddings within each hierarchical level. The model assigns a term frequency-inverse document frequency (TF-IDF) weight to each POI tag, calculating a weighted average of the POI embeddings associated with the AOL. This technique ensures that the embedding encapsulates both the density and diversity of POIs within the AOI, creating a robust vector representation of land use characteristics. This embedding is then used as input for a classifier.

Once POI embeddings are generated, an AOI embedding is computed by applying a weighted summation of the POI embeddings within the AOL. In one embodiment, the term frequency-inverse document frequency (TF-IDF) method is used to calculate weights, emphasizing POIs that are more representative of the AOI's unique characteristics. The weighted sum produces a high-dimensional AOI embedding that serves as a robust representation of land use characteristics within the AOI.

These AOI embeddings are then used as input for supervised land use classification models, which are trained to predict specific land use types based on AOI embeddings. This AOI representation learning framework enables scalable and accurate land use prediction across a variety of geographic regions, spatial scales, and semantic granularities.

The invention employs a supervised classification model to predict the land use type of the AOL. Using AOI embeddings as input features, the classifier is trained to recognize distinct land use types (e.g., residential, commercial, civic) across various spatial scales and semantic granularities. Training data comprises labeled land use polygons from OpenStreetMap (OSM), aggregated by road network boundaries to account for spatial context. Classifiers are trained to identify K land use types, with K being greater than or equal to 2, allowing for both broad and specific categorizations based on the AOI embedding.

This invention can be implemented as a data processing system comprising a processing unit and memory encoded with instructions to perform each step as described. Leveraging globally sourced POI data, such as the database curated by the PlanetSense project, the system enables scalable application across diverse geographic regions. By deploying the unified semantic framework and NNLM architecture, the system provides a practical, global solution for accurate, large-scale land use modeling, addressing limitations of traditional RS imagery-based methods.

Unlike existing RS-based approaches, which are often restricted by high computational costs and limited spatial coverage, this invention offers a scalable, POI-based model that fills the semantic gap left by RS imagery. By embedding POI semantics and spatial relationships within a hierarchical framework, the invention enables accurate land use classification that reflects both physical characteristics and socio-economic activities, making it suitable for global applications in areas such as security, urban planning, and disaster response.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A illustrates an exemplary spatial distribution of POIs aggregated from multiple data source within a selected region (South Africa), showing POI density and coverage variations.

FIGS. 1B-I illustrate exemplary spatial distributions of POIs from multiple data sources within South Africa, showing POI density variations.

FIG. 2 illustrates a spatial distribution of aggregated POI data from multiple data sources for South Korea.

FIG. 3 illustrates a spatial distribution of aggregated POI data from multiple data sources for England.

FIG. 4 illustrates an embodiment of the Area of Interest representation learning framework.

FIG. 5 illustrates an exemplary hierarchical space partitioning of three regions (South Africa, Korea, and England).

FIGS. 6A-C illustrates confusion matrices for 13-class classification models.

FIG. 7 illustrates exemplary land use modeling results.

### DESCRIPTION OF THE CURRENT EMBODIMENT

To overcome the limitations of traditional land use models, which often rely on remote sensing (RS) imagery, the present disclosure provides a novel approach to land use characterization that leverages diverse sources of Points of Interest (POI) data. In one embodiment, this invention employs a unified semantic representation framework and a neural network language model (NNLM) to transform heterogeneous POI data into embeddings that capture both spatial and semantic information for a designated area of interest (AOI). By integrating POI data from multiple sources, the disclosed techniques enable scalable, accurate land use characterization that reflects socio-economic activities as well as physical attributes.

An objective of the present disclosure is to create a systematic framework that harmonizes POI semantics across varied data sources and generates spatially explicit AOI embeddings. This framework organizes POIs within a spatial hierarchy according to road network boundaries and processes the semantic and spatial dimensions of POIs through an NNLM-based representation model. The resulting AOI embeddings provide rich information for predicting land use types, adaptable to different geographic contexts and spatial scales.

To illustrate the flexibility and effectiveness of the invention, three distinct geographic regions-South Africa, South Korea, and England—are provided as examples. These regions represent diverse economic and social environments, allowing for a comprehensive demonstration of how the invention's data fusion and semantic representation framework can be applied globally. The regions were selected based on their unique social and economic characteristics: South Africa, with its developing economy and varied landscapes; South Korea, with a highly urbanized environment and advanced technology infrastructure; and England, known for its dense population, mature economic development, and mixed land use patterns.

In one exemplary embodiment, POI data from each region is processed through the invention's data fusion, semantic harmonization, and NNLM-based embedding techniques. Using the invention's unified semantic framework, data from sources such as Facebook, Here, Vkontakte, Foursquare, OpenStreetMap (OSM), Wikimapia, Google, TomTom, and the World Resources Institute (WRI) are integrated to ensure comprehensive coverage of socio-economic activities within each AOI, regardless of regional or data source variability.

POI data is acquired by interfacing with available data sources through API calls or direct downloads. For example, POIs from publicly available sources such as OSM and Wikimapia are directly downloaded, while data from commercial sources such as Google and Facebook are collected through their respective APIs. Each POI includes semantic labels and geolocation data to characterize different land use types, as well as metadata on data source coverage and collection methods to ensure cross-source consistency. This data collection process is supported by the PlanetSense project, which provides a structured global database of POIs.

To account for differences in coverage across data sources and to capture a broad spectrum of land use information, the invention's data fusion process merges approximately 1,883,176 POIs for South Africa, 1,435,028 POIs for South Korea, and 3,253,419 POIs for England. The fusion process removes duplicate entries and harmonizes POI semantics across these sources to create a unified representation that reflects each region's socio-economic characteristics and human activity patterns. This extensive dataset enables the generation of AOI embeddings that robustly represent human dynamics and land use characteristics specific to each region.

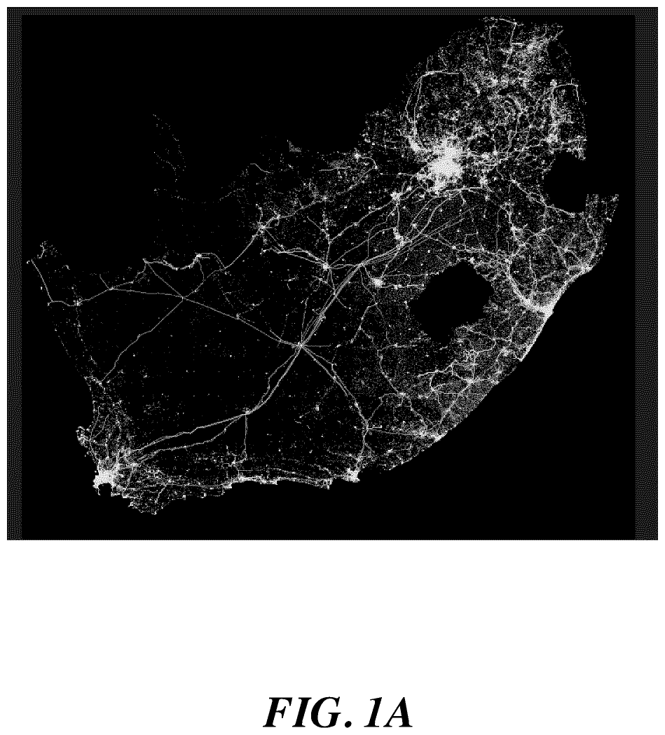

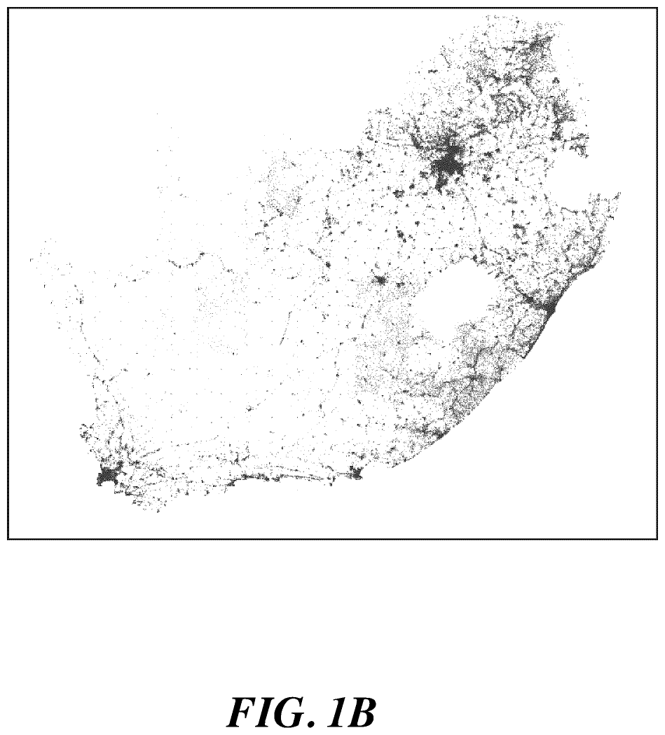

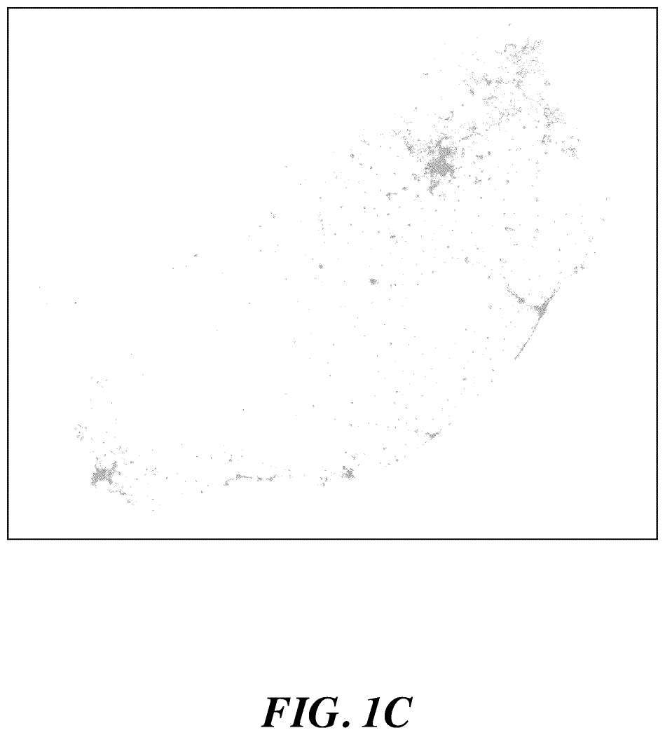

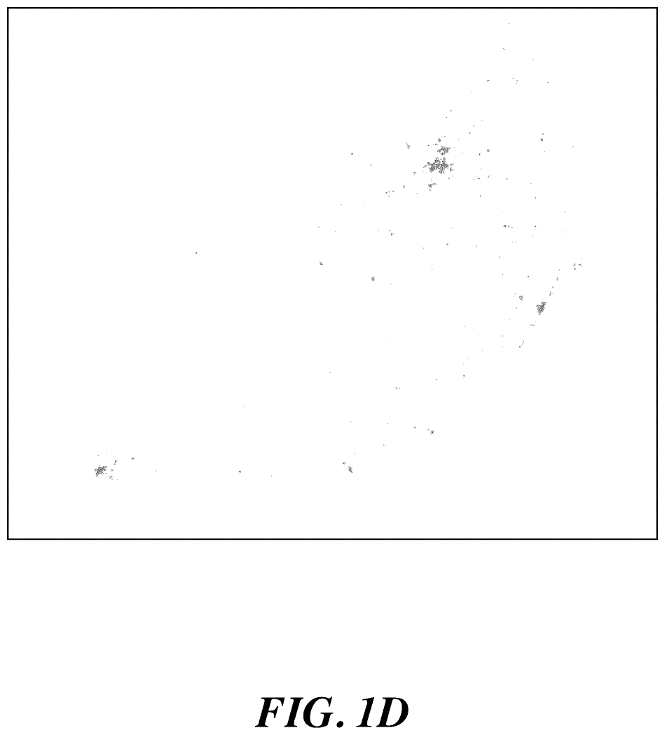

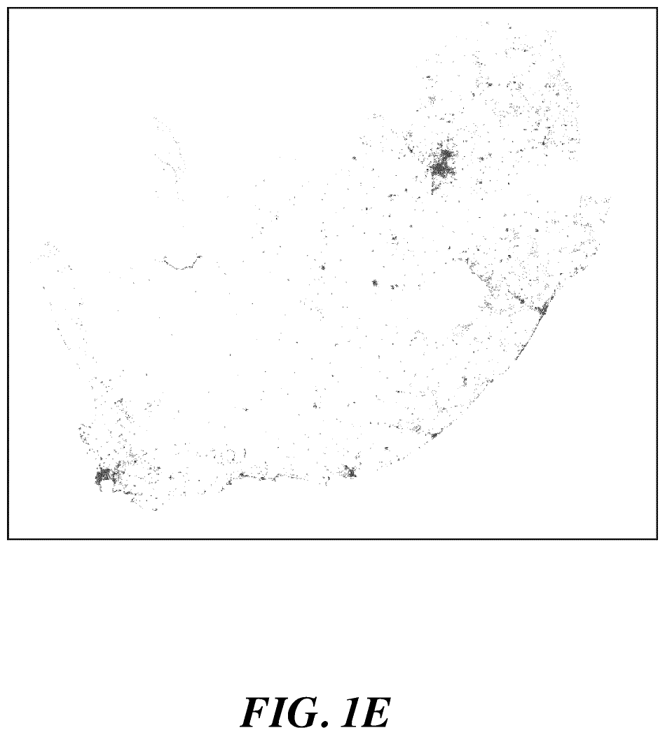

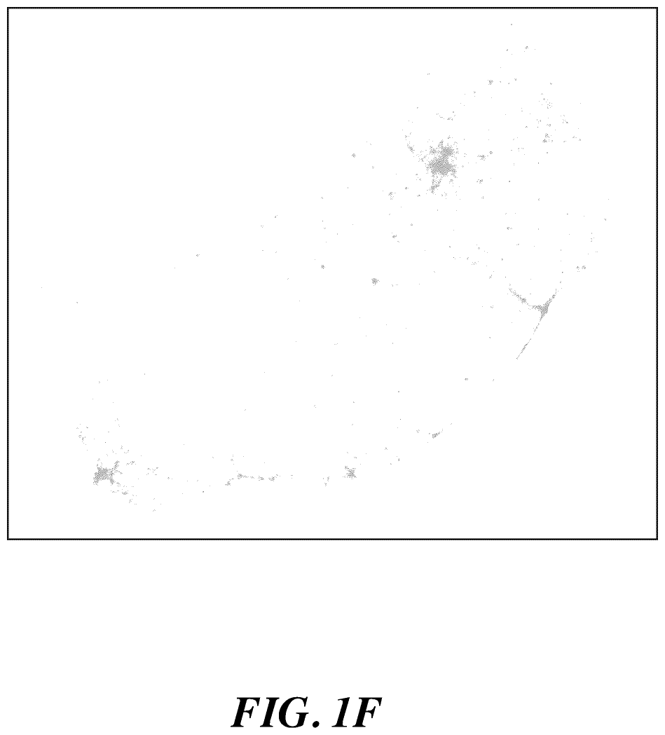

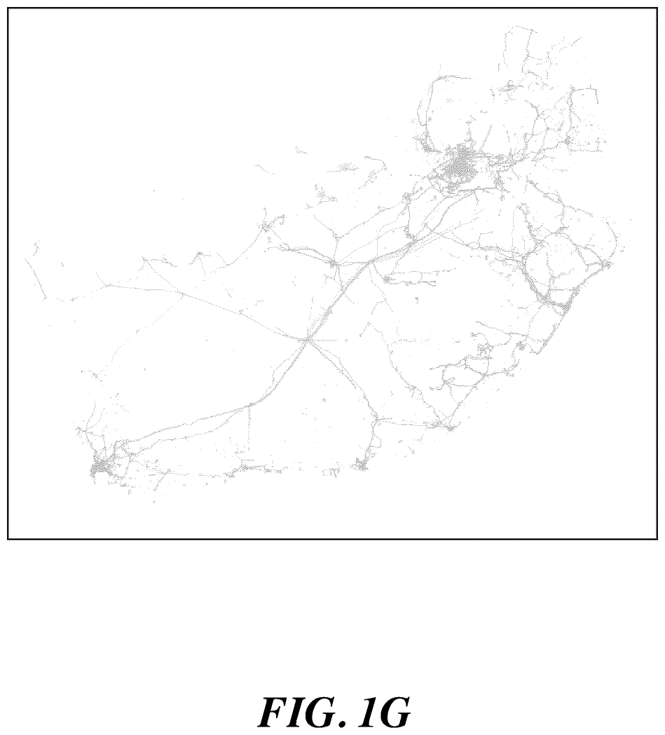

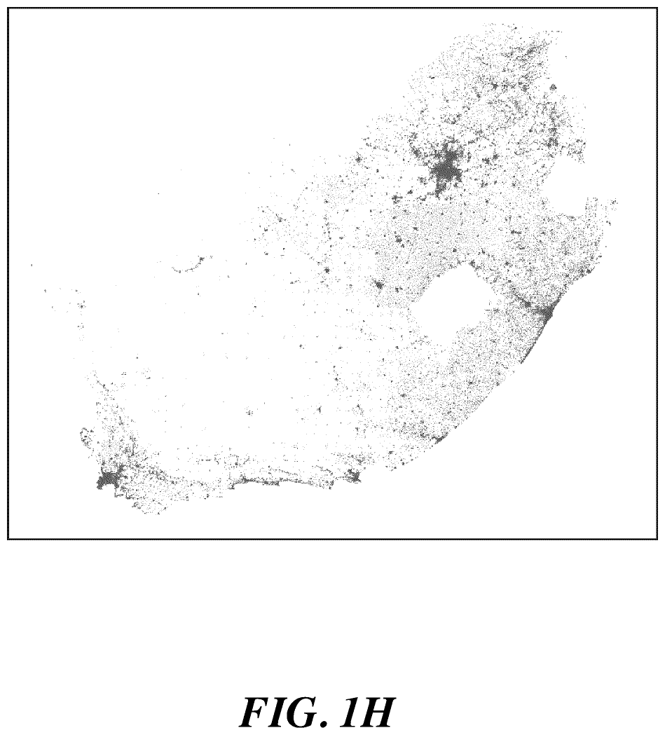

FIGS. 1A-I and 2-3 illustrate the spatial distribution of POIs from each data source within the selected regions, showing variations in POI density and coverage across South Africa, South Korea, and England. These distributions demonstrate the adaptability of the invention to diverse POI sources, as the framework can harmonize and integrate POI data across regions with differing social and economic contexts. By utilizing the invention's data fusion and semantic representation techniques, these example implementations validate the method's ability to produce meaningful AOI embeddings across varied geographic settings.

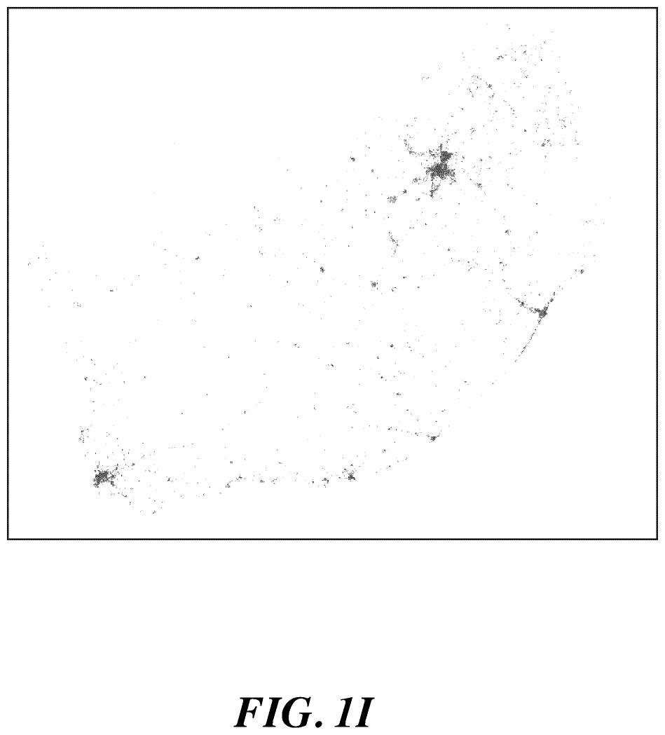

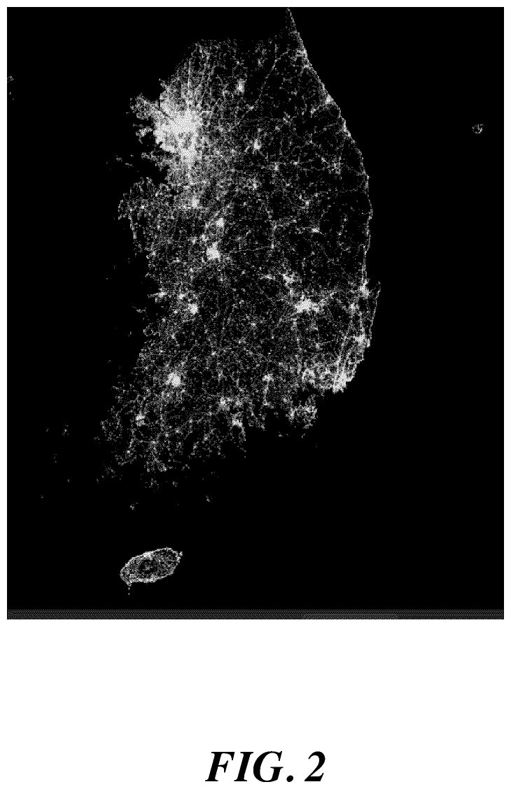

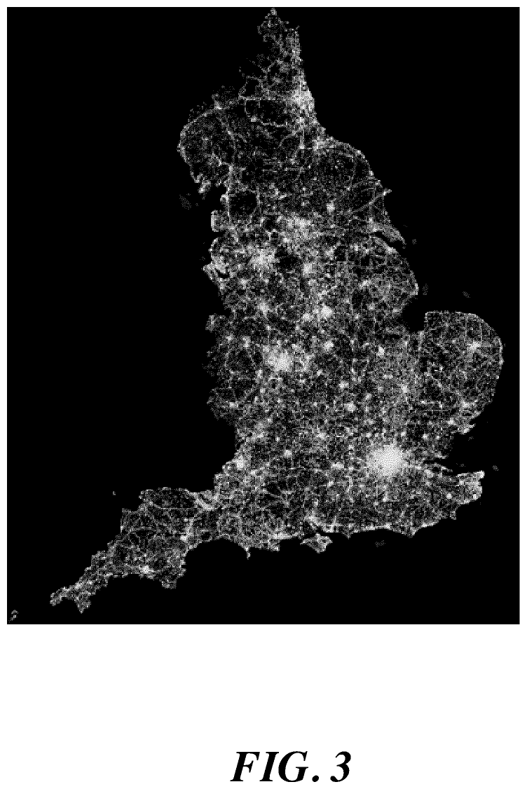

FIGS. 1A-I provide a detailed breakdown of POI data distributions within each region, depicting the variation in density and source coverage among different providers. For instance, the POIs collected from Foursquare (FIG. 1C), OpenStreetMap (OSM, FIG. 1E), TomTom (FIG. 1G), and Wikimapia (FIG. 1I) showcase diverse emphasis on POI types based on each source's unique data collection methods and geographic focus. FIG. 1A specifically depicts the aggregate POI distribution in South Africa, while FIG. 2 shows the aggregate distributions in South Korea and FIG. 3 in England. These variations in POI data distribution across regions highlight the importance of a unified semantic framework to ensure consistent and meaningful embeddings regardless of the data source. FIGS. 2 and 3 further illustrate the aggregated spatial distribution of POI data across South Korea and England, respectively, showing how the invention's data fusion techniques effectively produce integrated datasets that reflect each region's land use characteristics.

Embodiments of the present invention provide an Area of Interest (AOI) representation learning framework that captures land use characteristics through high-dimensional embeddings based on Points of Interest (POIs) within the AOL. This framework transforms each AOI into a representation that encapsulates both the spatial distribution and semantic attributes of POIs, which are indicators of socio-economic activities and land use. In one embodiment, the framework utilizes a neural network language model (NNLM) approach to produce these embeddings, creating a representation of AOI that is suitable as input for land use classification tasks. This approach enables scalable application of the model for characterizing land use across diverse regions and social-economic contexts globally.

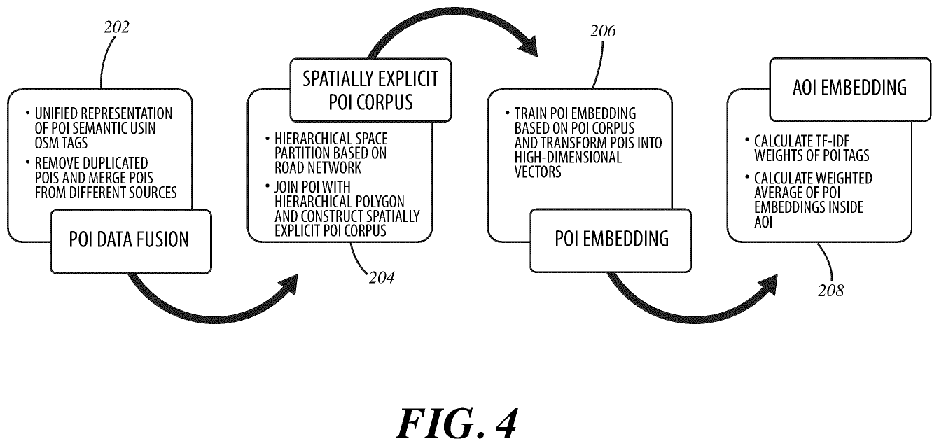

As shown in FIG. 4, the AOI representation learning framework includes four main components:
POI Data Fusion (202): The system provides semantic augmentation through unified representation of POI semantics. That is, POI data from multiple sources are harmonized to provide consistent semantic categorization based on tags, such as OpenStreetMap (OSM) tags. This process can also remove duplicated POIs and merge POIs from different sources.
Spatially Explicit POI Corpus Creation via Hierarchical Partitioning (204): The AOI is divided into spatial hierarchies based on road network levels, which allow for spatially contextualized analysis. In essence, by joining points of interest with hierarchical polygons a spatially explicit POI corpus can be generated.
Generation of High-Dimensional POI Embeddings (206): A neural network language model (NNLM) processes the spatially explicit POI corpus to create embeddings that capture both semantic and spatial dimensions of the POIs.
Calculation of AOI Embeddings through Weighted Summation of POI Embeddings (208): The AOI embedding is computed by applying a weighted sum of POI embeddings, enabling a composite representation of the AOI that can be used in supervised land use classification.

Unified Representation of Geographic Feature Semantics. The semantics of geographic features are central to accurately characterizing land use, as they reflect human interaction with geographic spaces. However, POI data sources often use unique categorization schemes, with differing levels of semantic granularity. For example, in England alone, Google Place POI data includes 101 different categories, Facebook data contains over 1300 categories, and Wikimapia data has thousands of unique entries, each varying in specificity.

To address this challenge, the present disclosure introduces a semantic ontology network, SONET, which interlinks diverse POI categories through a unified set of OSM tags. In one embodiment, each POI category is translated into one or more OSM tags that serve as an intermediary, allowing POIs from different sources to be harmonized into a common semantic framework.

OpenStreetMap (OSM) tags are attributes used within the OpenStreetMap (OSM) database to describe features on a map, such as roads, buildings, parks, and points of interest (POIs). Each feature in OSM is described using tags that consist of key-value pairs. These tags provide specific information about the feature, such as its type, function, or characteristics, and allow for a standardized representation of geographic data that can be used across various applications.

For example, as shown in Table 1, various categories form different data sources can be translated to OSM tags. Each OSM tag helps describe a geographic feature's purpose and specifics, making it easier to integrate and harmonize data from different sources. In your invention, these tags play a role in unifying POI categories from multiple sources into a common semantic framework, allowing for a more coherent representation of land use. For example, both “Yucatecan Restaurant” from Foursquare and “Mexican cuisine” from Wikimapia are mapped to the unified tags <amenity=restaurant; cuisine=mexican; building=retail>. This mapping allows the system to unify POIs with similar semantics but differing category labels.

TABLE 1
Example semantic translation from POI category to OSM tags

| Category | Data source | osm tags |
|---|---|---|
| Mexican Restaurant | Facebook | amenity=restaurant; |
| Yucatecan Restaurant | Foursquare | cuisine=mexican; |
| Mexican cuisine | Wikimapia | building=retail |

While OSM tags are utilized throughout this disclosure as a common framework for representing POI semantics, the disclosure is not limited to OpenStreetMap tagging conventions. OSM tags are provided here as an exemplary tagging system for harmonizing POI categories due to their widespread adoption and detailed categorization. However, any suitable system of tags or labels that organizes geographic features based on their functional and semantic attributes may be employed. For instance, tags or attributes from other geographic information systems (GIS), proprietary databases, or custom semantic ontologies could similarly be used to link and unify POI categories from diverse data sources within the disclosed framework.

The process of harmonizing POI categories across multiple data sources and translating them into a unified set of tags, such as OSM tags, can be performed automatically by the system. In one embodiment, an algorithm or software module is configured to match and assign suitable tags based on pre-defined mappings or semantic matching algorithms that recognize similarities between POI categories from various sources. For instance, the system may utilize a knowledge graph or a semantic ontology network to algorithmically link POI categories with corresponding tags. This automated tagging process ensures that POI data from different sources is consistently categorized, avoiding the need for manual intervention, and enabling large-scale application across diverse geographic datasets.

To further support large-scale analysis and create a consistent structure for land use characterization, the OSM tags can be further mapped into broader, functionally cohesive land use classes. Table 2 provides an example of this grouping, showing how specific OSM tags related to various geographic features can be mapped to unified classes. For instance, tags such as cemetery, grave, and graveyard can be grouped under a single “cemetery” class, while tags like park, sports_centre, and golf_course can be grouped under a “recreation” class. This grouping simplifies the analysis by abstracting granular tag data into higher-level, generalizable categories.

TABLE 2
Grouping of OSM land use classes

| Grouped class | Original class |
|---|---|
| agricultural | agricultural allotments animal keeping aquaculture farmland garden greenhouse |
| | greenhouse horticulture orchard pasture plant nursery vineyard |
| cemetery | cemetery grave_yard grave graveyard |
| civic | civic civic_admin community community_centre community_centre |
| | conference_centre government governmental institutional library service |
| | social_facility townhall clinic doctors health hospital school college university |
| natural | natural bare bare_rock basin beach conservation field flowerbed forest forestry |
| | grass grassland greenfield meadow nature nature_reserve reservoir sand scree |
| | scrub village_green water wetland wood |
| industrial | industrial brownfield construction depot landfill plant quarry |
| recreation | recreation camp_site caravan_site common dog park fishing golf golf_course |
| | holiday park leisure park pitch playground recreation_ground resort |
| | shooting_ground sport sports sports_centre stadium swimming theme_park |
| | water_park zoo observatory |
| religious | religious church churchyard place_of_worship monastery |
| residential | residential apartments village |
| retail | retail mall market marketplace |
| transportation | aeroway public transport railway highway |

The semantic ontology network framework of the present disclosure provides several advantages:
Semantic Harmonization: The use of OSM tags enables semantic equivalence between categories from different data sources, unifying diverse nomenclatures (e.g., “Mexican Restaurant” on Facebook and “Yucatecan Restaurant” on Foursquare).
Noise Reduction and Data Augmentation: By mapping category names to granular OSM tags, the framework reduces noise in the POI vocabulary and removes duplicates, which serves as a form of data augmentation for training POI embeddings.
Enhanced Granularity and Nuance: The OSM tags offer a finer semantic granularity, capturing detailed information about a POI's characteristics that may not be directly apparent from the original category name.

Building a Spatially Explicit POI Corpus. To account for the spatial dimension of POIs, the AOI can be hierarchically partitioned, for example, based on road network boundaries. In one embodiment, the road network is organized into four hierarchical levels, with each level providing spatial containment for the levels below it. However, the number of hierarchical levels used is not limited to four; rather, any suitable number of levels may be applied based on the specific requirements of the implementation, such as the complexity of the road network, the scale of the geographic area, or the desired granularity of spatial analysis. For instance, an embodiment applied to a densely urban area might benefit from additional levels to capture finer spatial distinctions, whereas a rural or less developed area could operate effectively with fewer levels. Each hierarchical level captures progressively broader spatial units and scales of analysis, from city blocks to neighborhoods and up to districts or even regions, allowing the framework to aggregate POI data at varying levels of detail.

This hierarchical organization enables POIs to be organized within spatially nested polygons corresponding to each level of the road network. Each level may represent, for example, different spatial units, such as city blocks at the lowest level, neighborhoods at the next, and districts at higher levels, with each level capturing a distinct spatial scale. By assigning each POI within an AOI to polygons at each hierarchical level, the invention constructs a spatially explicit POI corpus that supports multi-scale analysis of POI distributions. This multi-scale capability allows for fine-grained insights at lower levels and broader land use trends at higher levels, facilitating analyses tailored to different application needs.

The flexible hierarchical organization also supports the neural network language model's ability to analyze spatial and semantic dimensions of POIs simultaneously, thus enhancing the accuracy and richness of the land use representation. By structuring POIs according to nested spatial boundaries, the model can recognize and process POI patterns within the context of both local neighborhoods and broader regions, which may reveal important relationships that a flat, non-hierarchical structure might miss.

While leveraging road network boundaries is one suitable method for creating a spatial hierarchy, other structured spatial partitioning techniques can also be used within the framework. For example, hierarchical partitioning could alternatively be based on administrative boundaries, such as city, county, and state levels, which are meaningful in socio-economic contexts and human-centric land use analysis. Using structured and repeatable boundaries that align with human activity patterns enhances the framework's scalability and enables consistent, multi-scale analysis across diverse regions. This organization allows for systematic categorization of POI data, providing a reliable basis for large-scale applications where land use characteristics can be compared and analyzed across different geographic contexts.

To illustrate, consider a hierarchical structure based on road network boundaries, where the AOI contains nested polygons representing various spatial scales, such as city blocks, neighborhoods, and districts. Suppose an AOI includes several POIs, such as a restaurant, a retail store, and a park, each tagged to describe its function. The system queries the spatial boundaries of each polygon to identify individual POIs located within those boundaries, enabling it to determine both the count of POIs (e.g., 7 POIs in a city block) and the specific tags associated with each POI. For instance, a Mexican restaurant POI might be assigned tags like amenity=restaurant, cuisine=mexican, and building=retail, as shown in Table 1, where tags from different data sources are harmonized into a common representation. Additionally, based on these specific tags, the POI may also be categorized under a broader grouped class, such as “retail” as shown in Table 2. Similarly, a specific local park POI might carry tags such as playground and trees. It also might be classified under one or more grouped classes, such as recreation and nature.

These tags and grouped classes are then organized according to the polygons they occupy, forming a spatially organized POI corpus. Each polygonal level in the hierarchy thus contains a list of both detailed POI tags and broader grouped classes, describing the types and semantic attributes of POIs within that spatial scale, as well as the count of POIs at each level. This organization enables the system to capture multi-scale land use patterns, where higher-level polygons (e.g., districts) reflect broader semantic patterns, while lower-level polygons (e.g., city blocks) provide finer-grained details on both the quantity and types of POIs. This capturing of POI count, tag distribution, and grouped classes within each boundary enhances the system's capacity to represent both the density and diversity of land use characteristics across spatial scales, supporting applications in urban planning, resource allocation, and regional policy development.

Word Embedding for Semantic Representation. Word embedding, also known as the distributed representation of words, provides a quantitative method for capturing the semantic meaning of a word by learning from its contextual associations within a large corpus. In one embodiment, the invention employs a word embedding training algorithm, such as Word2Vec to map each word (or in this case, each POI tag) into a high-dimensional vector space. Word2Vec training algorithms quantitatively capture the semantic meaning of each word by analyzing the context surrounding the target word. The training objective in the Word2Vec model can be represented as follows:

$$arg {max}_{θ} {\prod }_{( w , c ∈ D )} p ( c \vert w ; θ )$$

Based on this objective, the training process operates in skip-gram mode, which improves the conditional probability of observing a word context c (i.e., words before and after the target word) given an input word www. In this context, c represents the set of all word-context pairs within the corpus. The parameter θ to be learned by the model is a V×N weight matrix, where V is the vocabulary size and N is the dimensionality of the vector representation for each word in the vocabulary. Through this training process, the model generates a high-dimensional embedding for each word, such that semantically related words are mapped closer together in the vector space.

In the context of the present invention, these embeddings are adapted to represent POI tags. Each tag is thus transformed into a high-dimensional vector based on its contextual relationship with other tags within the POI corpus. By using this distributed representation approach, the invention enables meaningful semantic comparisons between POIs, as tags that frequently appear in similar contexts are mapped to nearby vectors in the embedding space. This vector representation preserves semantic relationships, enhancing the invention's ability to analyze and predict land use patterns based on the spatial and semantic distributions of POIs.

Encoding Spatial and Semantic Dimensions in POI Embeddings. In the present invention, POI tags are modeled as words, with neighboring POI tags serving as the contextual words in the embedding process. By applying word embedding training algorithms to POI tags, each tag is mapped into a high-dimensional vector that encodes both spatial contextual information and semantic relationships. This approach allows the embeddings to integrate both the spatial distribution and semantic dimensions of POIs, creating a representation that reflects the spatial relationships and contextual meaning among POI tags within an AOI.

Consequently, when constructing the POI corpus it captures these spatial relationships among POI tags can be used as input for embedding training algorithms. By carefully modeling the POI corpus to retain spatial proximity and contextual associations among POIs, the invention ensures that the resulting embeddings accurately reflect both the spatial and semantic characteristics of the AOL. This dual encoding enhances the model's capability to analyze land use patterns based on the integrated spatial and semantic dimensions of POIs.

Building a Spatially Explicit POI Tag Corpus. Conventional approaches to defining the spatial context of a POI often rely on nearest neighbor relationships, which focus on proximity without fully considering the underlying structure of the road network. Such methods may overlook the natural spatial blocks formed by the road network, which play a significant role in shaping human activity and movement patterns. To better capture these contextual relationships, the present invention generates a hierarchical partitioning of space based on the road network hierarchy, such as shown in Table 3.

TABLE 3
Hierarchical space partition-based road network

| Level | Road network level |
|---|---|
| Level 1 | road segments that are higher than tertiary level roads, |
| | including motorway, primary,trunk, secondary, and tertiary |
| Level 2 | Level 1 + unclassified level roads |
| Level 3 | Level 2 + residential level roads |
| Level 4 | Level 3 + all the lower level roads |

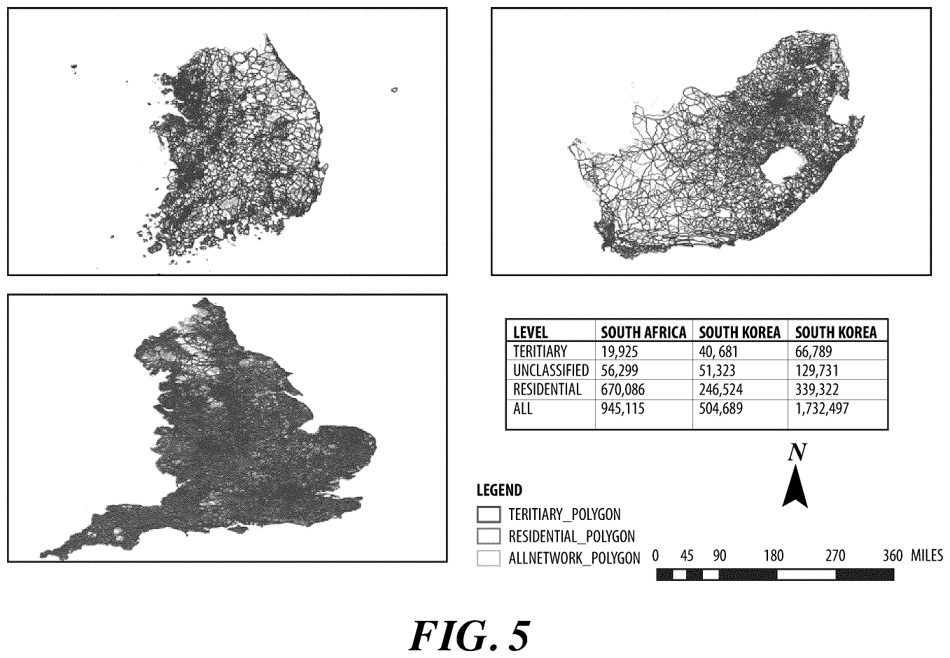

In one embodiment, the invention partitions the AOI into four hierarchical levels corresponding to different layers of the road network. Road network data may be sourced from OpenStreetMap (OSM) or a similar provider and then aggregated into four distinct levels, each representing a different hierarchy of road segments. FIG. 5 illustrates an example of the number of polygons generated through this partitioning approach across various levels. Each hierarchical level provides a unique spatial scale, allowing the system to capture POI relationships in a structured manner that reflects the road network's impact on geographic organization.

FIG. 5 shows the number of polygons for three study regions after partitioning using different levels of road networks. After hierarchical partition of space, POIs are spatially joined with partition results at four different levels. As a result, each POI is assigned four polygon IDs <l_{pid}¹, l_{pid}², l_{pid}³, l_{pid}⁴>, one polygon ID at each level of partition. Polygonₗ_{_{pid}}_{⁴} is inside Polygonₗ_{_{pid}}_{³} that is contained by Polygonₗ_{_{pid}}_{²}, which is inside Polygonₗ_{_{pid}}_{¹}. This hierarchical assignment captures both the immediate spatial context of each POI and its relationship to larger encompassing geographic areas.

Following this spatial assignment, POI categories from different sources are translated into a unified semantic representation using OSM tags, and these tags are modeled as “words” in a linguistic corpus. To capture both the semantics and geographic context of POIs, the POI tags are grouped hierarchically across the four polygon levels, with each level contributing to a progressively broader spatial grouping of tags.

After translating different POI categories from different data sources into a unified semantic representation, i.e., OSM tags, the OSM tags associated with each POI are modeled as words. The POI tags are grouped hierarchically from lowest level polygons to highest level polygons. Level 4 aggregation, created by grouping POI tags with the same l_{pid}⁴, groups all POI tags within the same street block and form a sentence of POI tags. Level 3 aggregation groups all the POI tag sentence with the same l_{pid}³ and creates POI tag paragraph. Level 2 aggregation groups all the POI tag paragraph with the same l_{pid}³ and creates POI tag document. After grouping all the POI tag documents with the same l_{pid}¹, we created a POI tag corpus that capture both the semantics of POIs and the geographic contextual relationships among POIs.

This structured, hierarchical approach creates a spatially explicit POI tag corpus that encodes both the spatial and semantic dimensions of POIs within the AOL. By leveraging road network-based hierarchical partitioning, the invention provides a more nuanced representation of land use patterns, enabling enhanced semantic and spatial insights at multiple levels of geographic context.

The spatially explicit POI corpus is then processed through a neural network language model (NNLM), which transforms the POI tags into high-dimensional embeddings. In one embodiment, each POI tag is converted into an N-dimensional vector, where N is a configurable parameter that defines the feature space used to encode semantic and spatial attributes of the POIs. High-dimensional embeddings are numerical representations in a multi-dimensional space, with each dimension capturing specific aspects of the POI's characteristics. The dimensionality N may be adjusted to balance the level of detail captured in the embedding with the computational resources available. Generally, higher dimensionalities enable more granular representations, although lower-dimensional embeddings may still provide sufficient accuracy for certain applications.

The NNLM is trained to recognize patterns within the POI corpus, capturing both relationships between different POI types and their spatial arrangement. By using high-dimensional embeddings, the model effectively learns to position similar POIs closer together in the embedding space, encoding meaningful patterns that enhance the richness of the POI representations. This process ensures that the resulting embeddings provide a robust foundation for generating accurate AOI representations that reflect both physical attributes and socio-economic activities within the area.

As used herein, high-dimensional embeddings refer to numerical representations in a multi-dimensional space where the dimensionality N is selected to capture the spatial and semantic characteristics of POIs effectively. In various embodiments, the number of high-dimensional embeddings may vary, e.g., in a range from tens to thousands of dimensions, although the exact dimensionality may be higher or lower depending on the complexity of the data and the computational resources available. For example, embeddings with 100 dimensions may be suitable for capturing broad relationships, while embeddings with 200 or more dimensions may offer enhanced granularity for applications requiring detailed semantic distinctions.

### Regional Variability in Semantic Context of Geographic Features

Table 4 illustrates the top five most semantically similar terms for 12 example geographic features based on the embedding results derived for three distinct geographic regions. These geographic features, which encompass various functional categories such as food, education, healthcare, entertainment, transportation, and public services, serve as examples of the invention's ability to capture regional semantic and spatial variations.

TABLE 4
Spatially explicit POI embedding results for different geographic regions

| | South Korea | South Africa | England |
|---|---|---|---|
| bar | biergarten nightclub pub | pub nightclub biergarten | pub nightclub restaurant |
| | internet_cafe cafe | cafe restaurant | biergarten cafe |
| college | campus high_school university | high_school campus nursery | adult education rnib campus |
| | humanities education | preschool school | school university |
| car_rental | fuel bicycle rental hertz | fuel restaurant truck_rental | car_wash nightclub |
| | rent car_repair | limo_service bicycle_rental | post_depot fuel cinema |
| clinic | doctors hospital yueoseu | doctors library arts_centre | arts_centre library theatre |
| | orakeul dentist | post office building | police fire_station |
| casino | cinema bar internet_cafe | nightclub restaurant bar | gambling nightclub cinema |
| | food_court nightclub | cinema pub | bar bicycle_rental |
| arts_centre | cultural_centre theatre | theatre library building | theatre events_venue |
| | animal_shelter planetarium | cultural_centre police | music_venue library |
| | events_venue | | cultural_centre |
| court_house | fire_station police policy | townhall police prison | townhall library police |
| | closest_town public_bath | post_office fire_station | arts_centre events_venue |
| playground | park pitch fitness_centre | park garden common | park common picnic_table |
| | sports_centre garden | golf_course pitch | pitch nature_reserve |
| grave_yard | bongeunsa hakdong seoripul | church taxi tennis_court | church tennis_court grit_bin |
| | nonhyeon eonju | garden_centre convenience | watering_place |
| | | | hunting_stand |
| mall | cosmetics shoes boutique | general supermarket video | variety_store houseware |
| | jewelry games | mobile_phone shoes | frozen_food electronics |
| | | | catalogue |
| church | cathedral denomination | religious religion service | chapel grave_yard |
| | deokposijang christian | times temple denomination | kindergarten |
| | chapel | | subdenomination childcare |
| industrial | warehouse man_made | mechanic solar panel antenna | warehouse works crescnt |
| | sagimakgol chemical | winery engineering | science_park knowlhill |
| | wind_energy | | factory |

The spatially explicit POI embeddings reveal both the unique semantics and the regional spatial context of these geographic features. Unlike embeddings generated from conventional text corpora, such as the Google News corpus, the spatially explicit embeddings produced by this invention reflect the geospatial semantics specific to each region. For example, while embeddings generated from general text sources might identify terms like “shopping mall” and “shopping plaza” as the closest semantic neighbors to “mall,” the spatially explicit embeddings generated by this invention reveal region-specific semantic variations. In one region, the embeddings for “mall” may include terms that refer to local store types and merchandise categories frequently found in similar geographic contexts, capturing regionally relevant commercial relationships.

These semantic differences across geographic regions also reflect cultural and economic diversity. For instance, the term “graveyard” yields different semantically similar terms based on regional context: in South Korea, “graveyard” is closely related to “bongeunsa,” a well-known Buddhist temple, reflecting local cultural significance, whereas in South Africa and England, “graveyard” is more closely associated with “church,” indicating a predominant association with Christian traditions. Similarly, for “playground,” the terms “park” and “common” appear as semantically similar terms in certain regions, though “common” is not associated with playgrounds in South Korea, where different language and cultural norms influence terminology.

The semantic consistency of POI embedding results varies by feature type across regions, providing insights into shared versus region-specific land use patterns. For features like “bar” and “casino,” the terms maintain a high degree of semantic similarity across regions; “bar” is associated with terms like “pub,” “nightclub,” and “biergarten,” while “casino” is associated with “nightclub,” “cinema,” and “bar” in all three geographic regions examined. Conversely, the semantics of “mall” exhibit significant variation across regions, indicating differences in how malls are perceived and utilized in different cultural and economic contexts.

By capturing these regional semantic distinctions, the invention enables land use modeling that reflects local cultural and functional dynamics, thereby enhancing the accuracy and applicability of geospatial analysis across varied geographic contexts.

Generating AOI Embeddings from POI Embeddings. In the present invention, each geographic Area of Interest (AOI) is modeled as a document, where the POIs within the AOI function analogously to words within a document. This approach enables the creation of an AOI embedding by aggregating the individual embeddings of the POIs it contains.

To calculate the AOI embedding, the invention employs a Term Frequency-Inverse Document Frequency (TF-IDF) weighting scheme to assign importance to each POI tag within a geographic area of interest. The TF-IDF score combines two components: term frequency and inverse document frequency.

The term frequency component, denoted as tf(p, s), calculates the frequency of a POI tag p within a spatial block s, reflecting how prevalent a specific POI tag is within the AOI. The inverse document frequency component, id measures the commonality of POI tag p across the entire region. This is calculated by taking the total number of spatial blocks in the region and dividing it by the number of blocks that contain the POI tag p, followed by computing the logarithm of this quotient.

The combined TF-IDF weighting can be represented by the formula:

$$tfidf ( p , s , S ) = t f ( p , s ) * idf ( p , S )$$

The TF-IDF weighting provides a weighted value that reflects both the relative frequency of a POI tag within the AOI and the uniqueness or rarity of that tag across the broader region.

This TF-IDF weighting method enables the AOI embedding to emphasize unique or locally significant POI tags while normalizing the weight of common features. For instance, frequently occurring geographic features such as “building” may appear in many spatial blocks and thus receive a lower TF-IDF score. This normalization prevents commonly occurring POIs from disproportionately influencing the AOI embedding, ensuring that the final representation more accurately reflects the distinctive characteristics of each AOI.

By aggregating POI embeddings in this weighted manner, the invention produces a comprehensive AOI embedding that encapsulates the spatial and semantic attributes of the area. This AOI embedding effectively represents the land use patterns, socio-economic activities, and cultural context of the AOI, providing a robust foundation for accurate land use classification and geospatial analysis.

Land Use Classification Modeling Based on AOI Embeddings. After mapping AOIs from geographic space into a high-dimensional semantic space and representing them as high-dimensional embeddings, a supervised classification approach is applied to analyze the impact of different spatial and semantic granularities on the representativeness of the AOI embedding. AOIs are created with two different spatial granularities and labeled according to two land use classification schemes, each with a distinct semantic granularity. For each unique combination of spatial and semantic granularities, the high-dimensional AOI embeddings are calculated and used as input features for training the supervised classification model.

The classification model's performance, evaluated using metrics such as f-score for each land use class, gauges the impact of spatial scale and semantic granularity on the semantic representativeness of AOI embeddings. The Random Forest algorithm was selected as the training algorithm due to its resilience against overfitting and its ability to handle variable correlations in high-dimensional, non-linear classification contexts (Louppe, 2014).

For each region, labeled land use polygon samples are collected from the OpenStreetMap (OSM) database as training data. Polygons are extracted from the OSM database if they contain a landuse=*tag, such as <landuse=retail>, with additional tags like aeroway=* and public_transport=* included to represent transportation land uses, thereby broadening the land use categories in the dataset.

The crowd-sourced land use polygons from OSM, labeled by volunteers, yield over 200 unique user-generated land use classes. However, many classes are infrequent, with only one or two instances in the database. The majority of land use polygons are labeled by one of the top thirty land use class labels. For robust analysis, only land use classes with at least five labeled polygon samples are included, and these selected classes are grouped into two classification schemes: one with three broad land use categories and another with 13 specific categories (shown in Table 4 and 5). Table 4 lists the grouping of all existing OSM land use classes in the training samples into 13 classes, while Table 5 shows the mapping of these 13 classes into a simplified three-class scheme.

This hierarchical classification structure enables the supervised model to evaluate the effectiveness of AOI embeddings across various spatial and semantic granularities. The resulting insights provide a robust basis for understanding the capacity of AOI embeddings to capture distinct land use patterns across diverse geographic contexts.

TABLE 5
Grouping of OSM land use classes (13 classes to 3 classes)

| Grouped class | Original class |
|---|---|
| ’open space’ | ’natural’ ’agricultural’ |
| ’residential’ | ’residential’ |
| ’non-residential’ | ’industrial’ ’retail’ ’commercial’ ’recreation’ |
| | ’transportation’ ’cemetery’ ’religious’ ’military’ |
| | ’civic’ ’utility’ |

The three-class classification scheme in this invention includes categories such as residential, non-residential, and open space. These general land use types, derived from established standards (https://www.planning.org/lbcs/standards/), are foundational for human dynamics research applications, including population modeling. The 13-class classification scheme, on the other hand, offers a finer level of semantic granularity, including classes such as agricultural, cemetery, civic, commercial, industrial, military, natural, recreation, religious, residential, retail, transportation, and utility. This more detailed scheme emphasizes human activity and describes specific types of activities or functions associated with each AOI, allowing for a more nuanced understanding of land use.

By offering these two levels of semantic granularity, the invention enables the comparison of AOI embeddings across different classification schemes, illustrating the impact of semantic granularity on the representativeness of AOI embeddings. Besides semantic granularity, the spatial granularity of an AOI and the number of POIs within it also influence the representativeness of the AOI embedding. The number of POIs within an AOI determines the richness of information captured by the embedding. For example, a single POI such as a parking lot may not sufficiently indicate the land use of an AOL. However, when additional POIs like a restaurant or salon are present, the AOI embedding becomes more indicative of the area's land use characteristics.

To ensure each AOI provides sufficient information without losing semantic coherence, the invention generates training samples using two spatial scales. One set of training samples uses the original user-defined boundaries for labeled land use polygons. Another set of training samples is generated through constrained spatial aggregation, which merges adjacent polygons with the same land use class if they are within a 30-meter radius of each other. Before aggregation, this exemplary embodiment utilized the following numbers of training samples for South Korea (228,323), South Africa (210, 853), and England (2,355,539) respectively. After spatial aggregation, these numbers reduce to 113,934 for South Korea, 97,688 for South Africa, and 730,656 for England, thus creating spatially consolidated AOIs that retain cohesive semantic information.

In addition to POI data, the invention extends the AOI representation learning framework to incorporate non-POI geographic features, which further enriches the AOI embeddings. Non-POI features, such as roads within an AOI, contribute to understanding land use characteristics, as they provide contextual information that complements POIs. To integrate non-POI features into the AOI embeddings, additional data on road networks and non-POI buildings were extracted from the OSM database for the three geographic regions. Each non-POI feature was transformed into a point by calculating the centroid of the road segment or building polygon, and associated OSM tags (e.g., <highway=footway>) served as a semantic representation for these features. The non-POI geographic features were then combined with POI data after spatial and semantic transformation and used as input for AOI embedding training.

This comprehensive approach, which incorporates both POI and non-POI data, enhances the AOI embeddings by providing a more holistic representation of land use characteristics. The combination of POIs and non-POI features within the embedding framework strengthens the model's ability to predict and classify land use patterns based on both human activity markers and structural elements of the geographic area.

Land Use Classification Model Performance. The supervised classification models were trained using eight different configurations (as shown in Table 6), which represent variations in sampling, spatial aggregation, and feature inclusion. The configurations are as follows:
Filtered Sample vs. All Sample: In the “all sample” configuration, all labeled training samples are used in model training. The “filtered sample” configuration, however, includes only those training samples that contain more than one geographic feature, ensuring that each AOI embedding provides a robust representation of the area's land use.
No Aggregation (no agg) vs. Aggregation with 30-Meter Threshold (agg30): The “no agg” configuration uses the originally labeled polygons as training samples without spatial aggregation. In contrast, the “agg30” configuration applies a spatial aggregation process, merging labeled polygons within a 30-meter distance threshold, which reduces the total number of training samples while preserving semantic coherence within each AOI.
POI Only (poi) vs. POI+Non-POI Features (all feature): The “poi” configuration trains the AOI embeddings solely on POI data, while the “all feature” configuration incorporates both POI and non-POI geographic features, such as road segments and building data, to enhance the semantic representativeness of the AOI embedding.

To ensure robustness in evaluating model performance, the supervised classification model was trained using stratified ten-fold cross-validation. This method partitions the data into ten subsets, or “folds,” each representing a balanced distribution of land use classes. The model is trained iteratively on nine of these folds while reserving the tenth for validation, repeating this process ten times so that each fold serves as a validation set once. This cross-validation approach provides a reliable measure of the model's performance, accounting for variability in the dataset and enhancing the generalizability of the classification results.

Three-Class Land Use Classification Modeling. Table 6 presents the f-scores for the supervised classification models trained with the eight different configurations. The f-score, calculated as the harmonic mean of recall and precision, serves as the primary performance metric, effectively accounting for both aspects of model accuracy.

TABLE 6
F-score of three-class land use classification models

| | South Africa | | | South Korea | | | England | | |
|---|---|---|---|---|---|---|---|---|---|
| | non- | open | | non- | open | | non- | open | |
| | resi | space | resi | resi | space | resi | resi | space | resi |
| all sample, no | 0.87 | 0.71 | 0.61 | 0.83 | 0.7 | 0.68 | 0.8 | 0.77 | 0.6 |
| agg, poi | | | | | | | | | |
| filtered sample, | 0.9 | 0.61 | 0.71 | 0.84 | 0.71 | 0.74 | 0.81 | 0.8 | 0.74 |
| no agg, poi | | | | | | | | | |
| all sample, | 0.82 | 0.56 | 0.6 | 0.74 | 0.54 | 0.55 | 0.81 | 0.56 | 0.62 |
| agg30, poi | | | | | | | | | |
| filtered sample, | 0.8 | 0.37 | 0.63 | 0.76 | 0.51 | 0.63 | 0.8 | 0.56 | 0.73 |
| agg30, poi | | | | | | | | | |
| all sample, no | 0.84 | 0.9 | 0.68 | 0.84 | 0.78 | 0.79 | 0.72 | 0.82 | 0.68 |
| agg, all feature | | | | | | | | | |
| filtered sample, | 0.87 | 0.82 | 0.76 | 0.84 | 0.78 | 0.82 | 0.76 | 0.77 | 0.76 |
| no agg, all feature | | | | | | | | | |
| all sample, | 0.78 | 0.71 | 0.64 | 0.82 | 0.67 | 0.72 | 0.71 | 0.63 | 0.68 |
| agg30, all feature | | | | | | | | | |
| filtered sample, | 0.82 | 0.66 | 0.74 | 0.79 | 0.61 | 0.76 | 0.74 | 0.6 | 0.73 |
| agg30, all feature | | | | | | | | | |

As shown in Table 6, the filtered sample, no agg, all feature configuration achieves the highest overall f-scores for classifying open space and residential land use categories across all three geographic regions. This configuration, which includes filtered samples, uses the original, non-aggregated labeled polygons and incorporates both POI and non-POI geographic features, indicating that this approach provides a comprehensive representation for these land use types.

For non-residential land use classification, however, the {filtered sample, no agg, poi}configuration achieves the best f-score, indicating that including non-POI geographic features in the AOI embedding does not significantly enhance the classification performance for non-residential areas. This suggests that POI data alone may provide sufficient information for characterizing non-residential land use.

The performance impact of including non-POI geographic features varies across the different geographic regions. England shows the largest performance improvement when non-POI geographic features are added, while South Korea exhibits minimal performance change. This variation across regions reflects differences in geographic context and the effectiveness of non-POI features in enhancing land use classification accuracy.

With respect to the {all sample vs. filtered sample}configuration, classification model performance improves for residential and non-residential land use classes after excluding training samples that contain only a single geographic feature. In contrast, the performance for the open space land use class experiences a slight decrease. This pattern is consistent across all three geographic regions. Notably, the non-residential land use class in South Africa shows the largest performance increase after filtering training samples. Generally, increasing the number of geographic features within an AOI enhances semantic richness and robustness in characterizing AOI land use. However, the performance decrease for open space land use indicates that the absence of geographic features can itself be a defining characteristic of certain land use types, such as open spaces.

Regarding the impact of spatial granularity ({no agg vs. agg30}), classification models trained on spatially aggregated samples tend to perform worse across the three land use classes in all three geographic regions. The open space land use class experiences the largest performance drop following spatial aggregation, while residential and non-residential classes see only a slight decrease in performance scores. The decline in model performance with spatial aggregation highlights the higher semantic coherence of the original, user-contributed boundaries compared to those generated through spatial aggregation.

For configurations involving non-POI geographic features ({poi vs. all feature}), adding non-POI features as additional input for AOI embedding training generally improves classification model performance for open space and residential land use classes, while decreasing performance for the non-residential class. This trend is consistent across all three regions. Without non-POI geographic features, land use polygons labeled as open space and residential classes lack sufficient semantically distinct features to fully capture their characteristics, resulting in lower classification scores. By incorporating non-POI geographic features, such as roads and non-POI buildings, the representativeness of training samples for open space and residential land use classes is improved, particularly in South Africa. In comparison, the performance changes for England and South Korea are less pronounced, potentially due to the more comprehensive and regular distribution of amenities and recreational facilities (e.g., benches, picnic tables) in developed areas, which better characterizes open spaces through POIs alone.

A three-class land use classification model for the three geographic regions was generated using the {filtered sample, no agg, all feature}configuration, as shown in FIG. B1. These results highlight the influence of geographic context on characterizing land use based on POIs. For non-residential land use, POIs alone offer better characterization of AOI land use type, as most POIs are associated with non-residential purposes. Consequently, adding non-POI features may dilute the semantic coherence of the AOI embedding for non-residential areas.

Overall, combining POIs with non-POI geographic features enhances the information captured by AOI embeddings, improving characterization of AOI land use types. Although non-POI features have limited semantic attributes, the spatial organization and distribution of these features, as captured by AOI embeddings, contribute significantly to the overall information about land use characteristics.

13-Class Land Use Classification Modeling. To examine the semantic representativeness of AOI embeddings at a finer level of semantic granularity, the invention includes a land use classification scheme with 13 distinct classes. These classes provide more specific land use categories, enabling a deeper analysis of how well the AOI embeddings capture nuanced land use characteristics.

Based on the results from the three-class classification models, the {filtered sample, no agg, all feature}configuration was selected as the optimal configuration for training the 13-class classification models. This configuration, which uses a filtered set of samples with no spatial aggregation and incorporates both POI and non-POI geographic features, was shown to enhance the model's performance and semantic coherence, making it well-suited for finer-grained land use classification.

TABLE 7
Classification performance of land use classes of 13-class model

| | South Africa | | South Korea | | England | |
|---|---|---|---|---|---|---|
| | precision | recall | precision | recall | precision | recall |
| agricultural | 0.88 | 0.78 | 0.69 | 0.59 | 0.58 | 0.52 |
| cemetery | 0.54 | 0.58 | 0.37 | 0.09 | 0.66 | 0.33 |
| civic | 0.85 | 0.9 | 0.79 | 0.86 | 0.82 | 0.74 |
| commercial | 0.4 | 0.23 | 0.51 | 0.33 | 0.4 | 0.14 |
| industrial | 0.58 | 0.55 | 0.8 | 0.58 | 0.6 | 0.45 |
| military | 0.62 | 0.04 | 0.65 | 0.29 | 0.31 | 0.03 |
| natural | 0.56 | 0.59 | 0.7 | 0.73 | 0.6 | 0.69 |
| recreation | 0.65 | 0.65 | 0.69 | 0.69 | 0.56 | 0.4 |
| religious | 0.8 | 0.68 | 0.89 | 0.72 | 0.67 | 0.53 |
| residential | 0.71 | 0.81 | 0.8 | 0.88 | 0.74 | 0.87 |
| retail | 0.82 | 0.91 | 0.65 | 0.67 | 0.7 | 0.77 |
| transportation | 0.84 | 0.7 | 0.78 | 0.67 | 0.71 | 0.53 |
| utility | 0.93 | 0.86 | 0.37 | 0.09 | 0.68 | 0.32 |

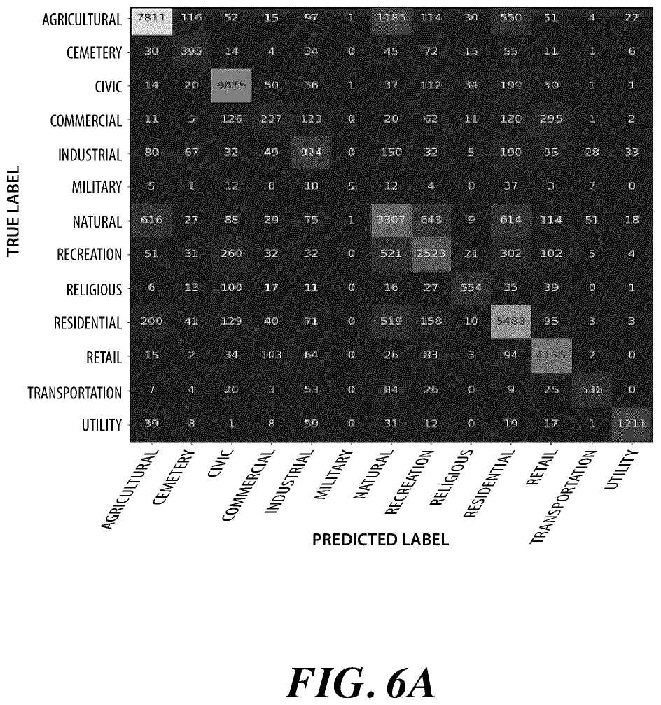

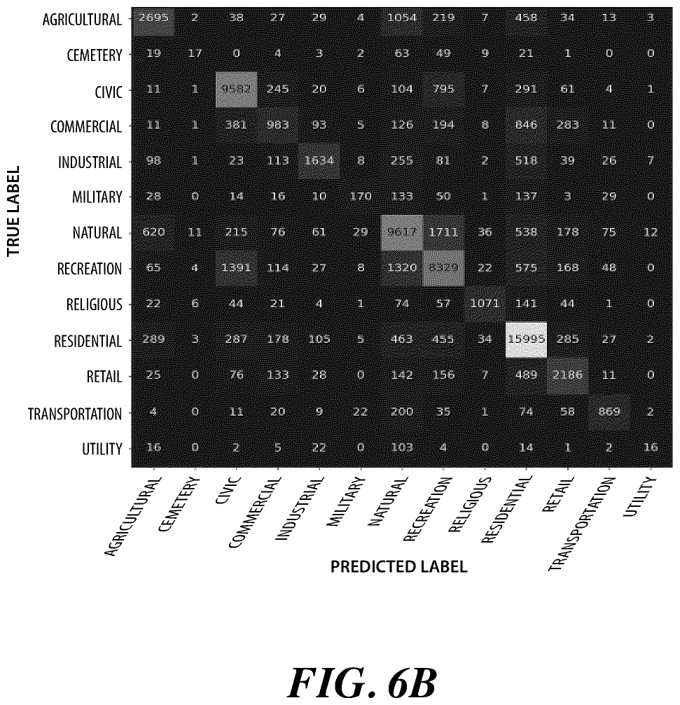

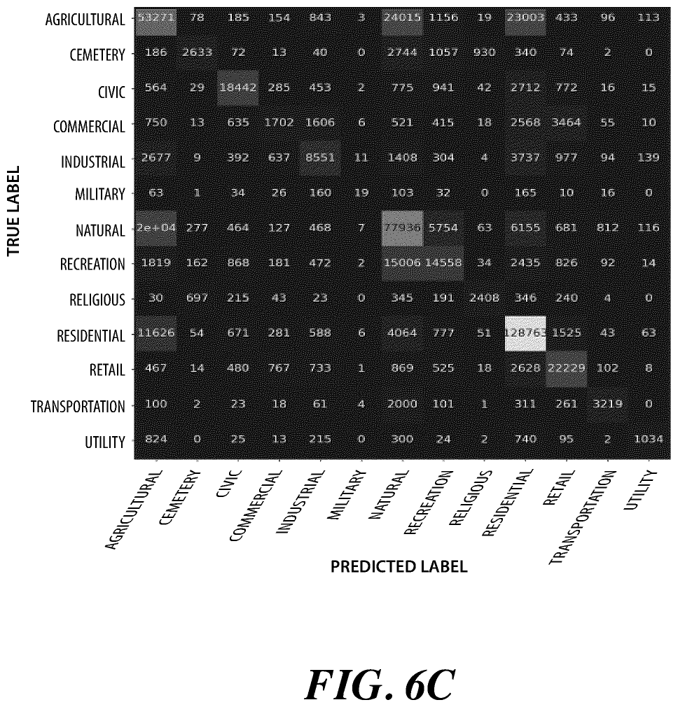

Table 7 presents the precision and recall scores for each of the 13 land use classes across the three selected geographic regions, highlighting the performance of the classification models at this finer level of semantic granularity. In South Africa, the land use classes with the highest performance scores are agricultural, civic, retail, and utility, with strong results also observed for religious, residential, and transportation classes. However, the commercial land use class shows the lowest performance scores. Several confusion matrixes are provided (See FIGS. 6A-C) for South Africa, South Korea, and England, respectively. The confusion matrix for South Africa (See FIG. 6A) reveals that commercial land use is frequently misclassified as retail and industrial, and agricultural land use is sometimes misclassified as natural or residential, a reasonable outcome given the mixed nature of farmland and residential areas within certain regions.

In South Korea, civic, religious, residential, and transportation land use classes perform the best, with industrial land use also showing high precision. The cemetery land use class, however, has the lowest performance scores, as it is often misclassified as natural or recreational land use. The confusion matrix for South Korea (See FIG. 6B) indicates that recreation land use is frequently misclassified as civic, and commercial land use is often misclassified as residential. This pattern may reflect unique socio-economic and demographic characteristics specific to South Korea. As the most mountainous region with the highest population density among the three study areas, South Korea has significant mixed residential and commercial land uses, which contributes to the observed classification overlap.

As shown in FIG. 6C, in England, the land use classes with the best performance scores include civic, natural, residential, and retail. Conversely, military and commercial land use classes show the lowest performance scores. Commercial land use is frequently misclassified as industrial, residential, or retail, while military land use is most often misclassified as industrial or residential. These patterns reflect the nuances of land use categorization in England, where commercial and industrial zones may exhibit similar characteristics.

The comparable classification accuracy across the three geographic regions demonstrates that AOI embeddings effectively capture land use characteristics specific to each area. When compared with the three-class land use classification models, certain fine-grained classes in the 13-class scheme, such as retail and civic, achieve similar or even improved performance scores. However, some fine-grained classes, such as commercial, exhibit lower performance, indicating that classification accuracy is generally higher for the three-class models due to their broader categories.

The distinct socio-economic and cultural contexts of each geographic region contribute to varying classification performance across land use classes. The insights provided by the confusion matrices reveal semantic similarities among different land use classes within each region, as well as the mixed nature of certain land use types. These insights can inform the design of tailored land use classification schemes that are optimized for specific geographic regions, ensuring that the classification model aligns with local land use patterns and context.

Land Use Modeling. Land use characteristics in a geographic region are closely associated with the socio-economic activities within it. Points of Interest (POIs), which play critical roles in daily activity patterns, serve as vital data sources for characterizing land use across diverse regions. With their open accessibility and broad availability, POI data provide an unparalleled opportunity to explore the effects of spatial scale, semantic granularity, and geographic context on POI-based land use modeling. To our knowledge, this invention is among the first to systematically examine these factors in large-scale POI-based land use modeling, offering significant value for policy makers, particularly in regions that require rapid decision-making or have limited official data. This work establishes a foundation for scalable, multi-dimensional POI-based land use modeling, benefitting social scientists such as geographers and economists.

This invention introduces an OSM-tag-based representation that enriches the semantic descriptions of both POIs and non-POI geographic features. The flexibility of OSM tags simplifies data fusion and augments the semantics of geographic features, optimizing the effectiveness of the neural network language modeling process. The developed AOI representation learning framework, combined with a versatile semantic representation of geographic features, facilitates easy extension of the framework to incorporate additional features in the learning process, thus enhancing the accuracy of land use characterization. By integrating road network hierarchy into POI embedding training, the invention captures both geographic structure and POI context, with embedding results that demonstrate the encoding of geographic and semantic information within a high-dimensional semantic space.

The invention's approach, which compares supervised land use classification models trained on varying spatial scales and semantic granularities, shows that original boundaries delineated by volunteer contributions retain a higher degree of semantic coherence than aggregated boundaries. Additionally, combining POIs with non-POI geographic features yields a more comprehensive characterization of AOI land use, strengthening the embedding's representation of local land use.

Classification performance scores reveal that the same land use types exhibit different levels of semantic salience across geographic regions, influenced by distinct social, cultural, demographic, and economic factors. Across the three studied regions, residential land use consistently demonstrates strong distinguishability based on POIs. Specific land use classes such as agricultural, civic, religious, retail, and transportation in South Africa; natural and transportation in South Korea; and civic and retail in England show high semantic salience. These variations reflect socio-economic and developmental differences among regions. The performance differences in the 13-class classification model indicate the current limitations of POI-based AOI embedding for capturing certain land use types in diverse regions, suggesting that the top-down 13-class scheme may benefit from regional customization.

While POI-based land use modeling presents an efficient and cost-effective means of generating large-scale land use maps, there are also limitations in the present research. Future work aims to address these by exploring the following areas. First, since the data used in this study is primarily crowd-sourced, the number of training samples for some land use types may be limited. Augmenting training data, either manually or through auxiliary data sources, could improve the AOI representation learning framework, enhancing characterization for land use classes with sparse samples. Second, integrating the temporal dynamics of POIs, such as opening hours, holds potential for capturing temporal variations in land use, providing deeper insights into the dynamics within an AOL. Future developments in these areas could extend the model's applicability and effectiveness, further advancing POI-based land use modeling.

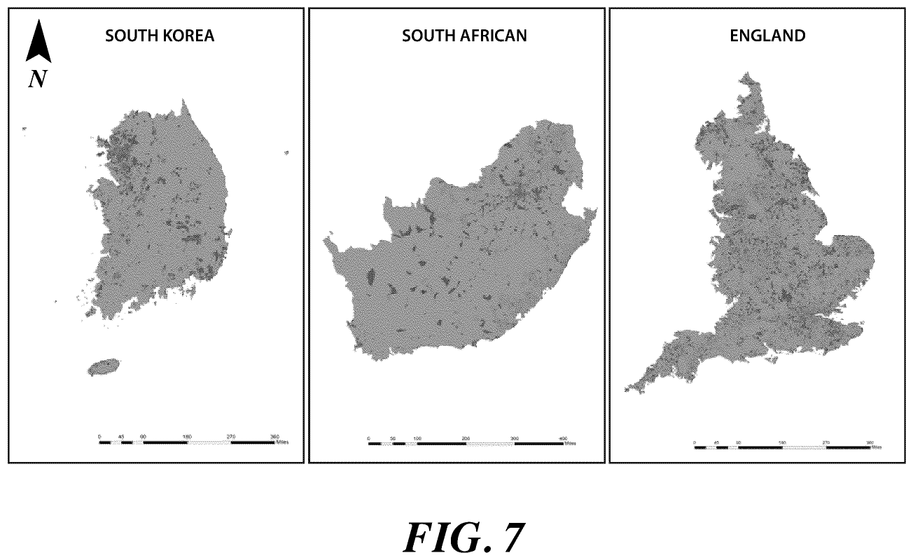

FIG. 7 illustrates exemplary land use modeling results generated with the present invention, showing mapped portions of areas categorized according to predicted land use types. In this figure, the mapped regions are visually segmented into three primary land use categories: non-residential, residential, and open space. The land use categories are color-coded to enhance interpretability and ease of reference. Specifically, non-residential areas are indicated in purple, open spaces in green, and residential areas in red. This color-coded representation aligns with the classification model's output, which categorizes each area based on aggregated Points of Interest (POI) data and embedded spatial-semantic features derived from the Area of Interest (AOI) embeddings.

The results shown in FIG. 7 exemplify how the present invention's model can translate complex POI data into easily interpretable visual maps, offering a clear overview of land use patterns across the AOL. This model output is designed to be accessible in two ways:

User-Accessible Visualization. The land use model depicted in FIG. 7 can be presented directly to users through an interactive interface, allowing users to select specific AOIs, refine spatial granularity, and observe real-time updates to land use classifications. This interactive access supports various applications, such as urban planning, environmental monitoring, and resource management, where stakeholders can view, interpret, and analyze land use distributions.

Automated System Access. The mapped output shown in FIG. 7 can also be accessed by automated systems through an application programming interface (API). In this configuration, external systems can query the model for specific AOI predictions and retrieve land use categories in a structured data format, allowing for integration into larger analytical pipelines. Automated access supports applications such as disaster response, logistics planning, and large-scale urban analytics where real-time land use data is valuable for operational decision-making.

### User Interface for Area of Interest (AOI) Selection, Dynamic Refinement, and Land Use Prediction

The disclosed system can incorporate a user interface designed to facilitate user interaction with the classifier model for land use prediction within a selected AOI. The interface provides functionality for user-driven AOI selection, customization of spatial granularity, real-time updates of classifier predictions, and display of additional prediction metrics, fulfilling the claimed elements as follows:

### AOI Navigation and Interactive Map Selection:

The user interface can feature an interactive map that displays different geographic regions. Users can navigate, zoom, and pan across the map to locate a specific AOI, enabling flexible exploration across a variety of spatial regions and scales. This interactive capability is designed to support the user in visually selecting the desired AOI location by adjusting the map view and position.

Within this map interface, users can select the AOI by specifying boundaries at varying spatial granularities, using hierarchical polygon levels that correspond to pre-defined spatial units within the multi-level hierarchy established by the classifier model. Each polygonal level within the hierarchy represents a distinct spatial scale-such as neighborhood, district, or city region—and allows users to select granular or broad AOIs based on their needs.

The selected AOI's boundaries directly influence the classifier model's analysis, as each user-selected polygon level dynamically updates the underlying POI data and corresponding spatial embeddings associated with the AOL. This process enables users to obtain model predictions specific to their selected region and level of detail, achieving a seamless integration of the AOI selection with the classifier model's analytical framework.

Dynamic Refinement of AOI Boundaries and Granularity. Once the AOI is selected, the user interface allows users to refine the AOI boundaries through a dynamic refinement tool. This tool provides the user with the ability to adjust the spatial extent and granularity of the AOI by zooming in or out on the map, thereby modifying the coverage of the area under analysis. As users refine the AOI boundaries, the classifier model automatically recalculates the analysis based on the newly adjusted area, enabling a real-time update of the predicted land use category. This real-time update function leverages the harmonized POI data relevant to the modified AOI, providing users with instant feedback as they fine-tune the spatial extent of their area of interest.

By allowing the AOI to be dynamically refined and recalculated on demand, the system ensures that users can obtain customized predictions tailored to both the desired geographic scale and specific user-defined boundaries. This interactive refinement process enhances the model's utility in scenarios requiring high flexibility and precise spatial adjustments, meeting the needs of users or systems that may be interested in detailed analyses within narrowly defined areas or broader overviews covering larger regions.

Initiation of Prediction Operation and Display of Output: Upon finalizing the AOI selection and any refinements, users can initiate a prediction operation through the interface, triggering the classifier model to analyze the AOI using the current spatial and semantic embeddings of POIs within the selected area. The prediction operation results in an output that displays the predicted land use category for the AOI, derived from the unified semantic and spatial embeddings of POIs associated with the selected boundaries.

The predicted land use category is prominently displayed within the interface, providing users with an accessible and interpretable view of the model's output. Additionally, confidence metrics are presented alongside the prediction, allowing users to assess the certainty of the classifier model's output based on factors such as POI density, diversity, and the reliability of POI semantic tags within the AOL. The confidence metrics are calculated by the classifier model and give users insight into the robustness of the land use prediction, enhancing transparency and trust in the system's predictive accuracy.

Saving of AOI Selection and Prediction Results. To support ongoing analysis, the interface allows users to save the selected AOI, its predicted land use category, and associated confidence metrics for future reference. This save feature provides users with the ability to store and compare multiple AOI selections, enabling comparative analysis across different AOIs with varying spatial granularities or geographic locations. Saved data can be revisited for additional analysis or documentation, allowing users to systematically explore land use characteristics across diverse regions within a single interface.

Classifier Model's Dimensionality Adaptation Based on AOI Selection. In some embodiments, the classifier model is configured to adapt the dimensionality of POI embeddings according to the spatial granularity of the selected AOL. This adaptation mechanism optimizes the balance between processing efficiency and prediction accuracy, as the embedding dimensionality can be scaled based on the level of spatial detail required by the user-defined boundaries.

For instance, when users select a highly granular AOI, such as a neighborhood or block level, the model may allocate additional dimensions to POI embeddings to capture fine-grained spatial and semantic relationships between POIs. Conversely, for broader AOIs, such as city districts, the model may adjust dimensionality to emphasize broader spatial patterns while reducing computational demands. This dynamic adjustment feature ensures efficient processing across a range of AOI sizes, improving both the performance and adaptability of the model for large-scale or high-resolution applications.

Display of Key Semantic Features Contributing to Predicted Land Use. For enhanced interpretability, the user interface further provides a visual breakdown of key semantic features within the AOI that contributed to the predicted land use category. This breakdown highlights the most influential POI tags and spatial attributes, enabling users to understand the specific factors that guided the classifier model's decision. By displaying this feature information, the interface enhances user comprehension of the model's reasoning process and supports transparent analysis of land use predictions.

Through this comprehensive set of features, the user interface provides a practical and user-friendly platform for interacting with the trained classifier model to predict land use categories for selected AOIs. Each element of the interface supports the user in navigating, refining, and understanding land use predictions across multiple spatial scales.

Automated System Integration for Programmatic Land Use Prediction. In addition to direct user interaction via the user interface, the disclosed land use prediction tool is configurable for integration with automated systems that can query the model programmatically. This configuration supports a variety of applications where automated, large-scale, or real-time land use predictions are required, eliminating the need for individual user access to the interface.

In this embodiment, external systems can connect to the land use prediction tool through an application programming interface (API), allowing remote systems to submit queries for specific AOIs and receive land use predictions in response. The API supports inputs such as geographic coordinates, AOI boundaries, and requested spatial granularity, enabling the automated system to specify the parameters of the AOI without requiring manual selection. This setup allows for seamless and continuous operation, particularly useful in scenarios where real-time land use monitoring, large-scale data analysis, or automated decision-making is involved.

For example:

Urban Planning Systems: Municipal or regional planning software can automatically query the prediction tool to assess land use changes across an entire city or county. By periodically submitting updated AOI coordinates, the system can track shifts in land use categories as new development projects or zoning changes occur.

Disaster Response Systems: Automated disaster response systems can query the model to understand land use characteristics of impacted areas, assisting in resource allocation and logistical planning by identifying commercial, residential, and civic zones within disaster-affected regions.

Transportation and Logistics Systems: Logistic operations can incorporate the tool's predictions into route planning by querying for land use categories along transportation corridors, enabling optimized route adjustments based on land use patterns.

In each of these cases, the prediction tool processes the AOI query in the same manner as it would for direct user input, applying the harmonized POI data, spatial embeddings, and classifier model to generate a land use prediction. However, instead of displaying the results on the interface, the output is delivered back to the querying system through the API in a standardized format, such as JSON or XML. This format allows the querying system to parse and integrate land use predictions seamlessly into its operational processes or further analyses.

The automated system integration offers scalability and adaptability, making the land use prediction tool suitable for deployment within larger geospatial analysis pipelines, autonomous decision-making systems, and high-frequency data monitoring frameworks. By enabling programmatic access, the disclosed tool extends its application scope, allowing both interactive and automated land use characterization across multiple scales and geographic regions.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. Memory encoding instructions that, when executed by data processing apparatus, cause the data processing apparatus to perform operations comprising:
accessing, from multiple data sources, information about points of interest (POIs) within an area of interest (AOI), wherein information about each POI comprises at least the POI's semantic attributes and geolocation;
harmonizing the POI information by representing the accessed POI semantics information using a unified format, removing duplicated POIs, and merging POIs from the different data sources based on the harmonized POI information;
constructing a spatially explicit POI corpus by
accessing information about a road network, wherein at least a portion of the road network spatially overlaps the AOI, and wherein the road network information comprises hierarchical levels of the road network's segments,
partitioning the AOI into polygons constructed from segments at the same hierarchical level, wherein a polygon at a particular level is nested inside another polygon at a lower level,
assigning each POI to the polygons that contain the POIs' geolocations, such that each POI is associated with polygons across respective hierarchical levels;
generating POI embeddings based on the constructed spatially explicit POI corpus;
generating AOI embeddings based on the generated POI embeddings; and
using the generated AOI embeddings as input for training a classifier to predict land use types for an AOI.

2. The memory of claim 1, wherein the unified format comprises a standardized set of tags, including OpenStreetMap tags.

3. The memory of claim 1, wherein tags associated with each POI are modeled as words, and are hierarchically grouped from lowest-level polygons to highest-level polygons, such that:
groups of POI tags corresponding to highest-level polygons form POI-tag sentences,
groups of POI-tag sentences corresponding to next lower-level polygons form POI-tag paragraphs,
groups of POI-tag paragraphs corresponding to before-lowest level polygons form POI-tag documents, and
groups of POI-tag documents corresponding to the lowest level polygons form a POI-tag corpus.

4. The memory of claim 1, wherein the generating the POI embeddings includes transforming POI tags into respective N-dimensional vectors, where N is greater than or equal to the number of hierarchical levels of the road network.

5. The memory of claim 4, wherein the producing the POI embeddings is performed using a neural network language model.

6. The memory of claim 1, wherein the generating the AOI embeddings comprises:
calculating term frequency-inverse document frequency (TF-IDF) weights of the POI tags, and
using the TF-IDF weights to calculate a weighted average of POI embeddings associated with an AOI.

7. The memory of claim 6, wherein the determining AOI embeddings is performed using a neural network language model.

8. The memory of claim 1, wherein the instructions cause the data processing apparatus to organize POIs into multi-level spatial hierarchies, allowing the neural network language model to analyze both spatial and semantic attributes of POIs.

9. A system for predicting a type of land use for an AOI, the system comprising:
a data processing apparatus; and
the memory of claim 1, wherein the land use type is one of a predetermined set of land use types.

10. The system of claim 9, wherein POIs in the AOI comprise at least one of schools, hospitals, and touristic sites.

11. A method implemented by a data processing system for characterizing land use within an area of interest (AOI), the method comprising:
retrieving, from multiple geospatial data sources, information regarding points of interest (POIs) within a defined AOI, where the information includes spatial coordinates and categorical identifiers for each POI;
applying a standardized tagging schema to normalize categorical identifiers across POIs from different data sources, creating a unified semantic format for subsequent processing;
constructing a multi-level spatial hierarchy by:
accessing hierarchical boundary data representing physical infrastructure, such as road networks, associated with the AOI, the hierarchy comprising multiple spatial levels representing progressively broader regions within the AOI; and
segmenting the AOI into nested polygons according to hierarchical boundary levels, creating a spatial structure where each polygon at a given level is nested within polygons at higher levels;
mapping each POI to a set of spatial polygons across hierarchical levels that contain the POI's spatial coordinates, generating hierarchical associations that encode both local and regional spatial context;
generating a high-dimensional semantic vector for each POI based on its standardized categorical identifier and assigned hierarchical polygons, wherein each vector captures both the spatial and semantic attributes of the POI;
computing an aggregate AOI embedding by combining the semantic vectors of POIs located within the AOI, applying term frequency-inverse document frequency (TF-IDF) weighting to emphasize distinctive POIs relevant to the AOI's land use characteristics;
training a classifier model using the computed AOI embeddings from multiple AOIs labeled with land use categories, the model configured to predict land use type based on the spatial and semantic information encoded in the AOI embeddings; and
using the trained classifier model to predict a land use category for the AOI by analyzing the aggregate AOI embedding.

12. The method of claim 11, wherein the standardized tagging schema comprises OpenStreetMap (OSM) tags to facilitate cross-source compatibility and semantic coherence.

13. The method of claim 11, wherein generating a semantic vector for each POI includes applying a neural network language model trained to encode geographic and functional attributes of POIs into N-dimensional embeddings.

14. The method of claim 11, wherein the TF-IDF weighting applied in the AOI embedding calculation emphasizes unique POIs with semantic importance within the AOI, improving representational accuracy for land use classification.

15. The method of claim 11, wherein the classifier model incorporates feedback data from user inputs or updated land use data to adapt and refine the classification predictions over time.

16. The method of claim 11, wherein the data processing system is configured to dynamically adjust the dimensionality of the POI embeddings to balance computational efficiency and classification accuracy based on the complexity of data within each AOI.

17. The method of claim 11, wherein the classifier model is trained to categorize the AOI into multiple land use categories, including residential, commercial, agricultural, recreational, and utility areas, based on the semantic and spatial attributes encoded within the AOI embedding.

18. A system for predicting land use categories within a user-selected area of interest (AOI), the system comprising:
a data processing apparatus configured to perform operations comprising:
retrieving, from multiple geospatial data sources, information regarding points of interest (POIs) within a defined AOI, the information comprising spatial coordinates and categorical identifiers for each POI;
applying a standardized tagging schema to normalize categorical identifiers across POIs from diverse data sources, creating a unified semantic format for subsequent processing, including the removal of duplicate POIs and integration of POIs based on their harmonized attributes;
constructing a multi-level spatial hierarchy by:
accessing hierarchical boundary data representing physical infrastructure, including road networks, associated with the AOI, the hierarchy comprising spatial levels that represent progressively broader regions within the AOI, and
segmenting the AOI into nested polygons according to the hierarchical boundary levels, creating a spatial structure where each polygon at a given level is nested within polygons at higher levels;
mapping each POI to a set of spatial polygons across hierarchical levels that contain the POI's spatial coordinates, thereby generating hierarchical associations that encode both local and regional spatial context for each POI;
generating a high-dimensional semantic vector for each POI based on its standardized categorical identifier and assigned hierarchical polygons, wherein each vector captures both spatial and semantic attributes of the POI;
computing an aggregate AOI embedding by combining the semantic vectors of POIs within the AOI, applying term frequency-inverse document frequency (TF-IDF) weighting to emphasize distinctive POIs relevant to the AOI's land use characteristics;
training a classifier model using the computed AOI embeddings from multiple AOIs labeled with land use categories, the model configured to predict land use type based on the spatial and semantic information encoded in the AOI embeddings; and
a user interface configured to enable a user to:
interact with an interactive map displayed on the user interface to navigate, zoom, and pan across different geographic regions to locate an AOI of interest;
select and define the AOI within the map by specifying boundaries at varying spatial granularities through hierarchical polygon levels, each selection dynamically updating the classifier model's analysis based on the harmonized POI data within the selected AOI;
refine the AOI boundaries within the selected granularity level by adjusting the AOI's spatial extent on the map, thereby customizing the area covered in the classifier model's land use prediction;
initiate a prediction operation to receive a displayed output of the predicted land use category for the selected AOI, generated by the classifier model and derived from the unified semantic and spatial embeddings of POIs within the AOI; and
display confidence metrics for the predicted land use category, save the selected AOI, its predicted category, and associated prediction details, facilitating comparative analysis across multiple AOIs at varying spatial granularities.

19. The system of claim 18, wherein the user interface provides a dynamic refinement tool enabling the user to interactively adjust the spatial extent and granularity of the AOI by zooming in or out on the interactive map, thereby updating the classifier model's analysis in real-time based on the adjusted AOI boundaries, and displaying the refined predicted land use category as the user redefines the AOI.

20. The system of claim 18, wherein the classifier model adapts the dimensionality of the POI embeddings according to the selected spatial granularity of the AOI to balance processing efficiency and prediction accuracy, and wherein the user interface further provides a visual breakdown of key semantic features within the AOI that contributed to the predicted land use category, enhancing user understanding of the classifier model's output and improving interpretability across different spatial granularities.
